(19) United States
(12) Patent Application Publication
(10) Pub. No.: US 2024/0021849 A1
(43) Pub. Date: Jan. 18, 2024

(54) AIRCRAFT FLUID RELEASE SYSTEM

(71) Applicant: GKN AEROSPACE SERVICES LIMITED, (US)

(72) Inventor: Simon Taylor, Shirley, Solihull (GB)

(21) Appl. No.: 17/768,487

(22) PCT Filed: Oct. 16, 2020
(86) PCT No.: PCT/GB2020/052615

§ 371 Date: Apr. 13, 2022

(30) Foreign Application Priority Data
Oct. 16, 2019 (GB) 1914997.0

(51) Int. Cl. H01M 8/04119; H01M 8/0432; H01M 8/0438; H01M 8/04492

(52) U.S. Cl. CPC H01M 8/04156; H01M 8/0432; H01M 8/0438; H01M 8/04492; B64D 27/24

(57) ABSTRACT

A fluid release system for a fuel cell comprises a conduit for communicating water from the fuel cell to one or more outlets; and, a water discharge arrangement arranged to selectively release water from the one or more outlets, wherein the water discharge arrangement is arranged to controllably open the one or more outlets to selectively release water from the one or more outlets.

### CROSS-REFERENCE TO RELATED APPLICATIONS

This application is a national stage of, and claims priority to, Patent Cooperation Treaty Application No. PCT/GB2020/052615, filed on Oct. 16, 2020, which application claims priority to Great Britain Application No. GB 1914997.0, filed on Oct. 16, 2019, which applications are each hereby incorporated herein by reference in their entireties.

### BACKGROUND

According to most estimates, airline traffic is set to double every fifteen years providing a significant increase in the operation of land-based and, subsequently, airborne propulsion systems and therefore the production of associated emissions. Emissions are known to be harmful whether produced at ground level or at altitude.

In order to meet targets for reduction of emissions set by the International Air Transport Association, the use of alternate fuels has been identified as a possible avenue of exploration. Alternate fuels include biofuels, synthetic kerosene, compressed natural gas. In addition, the ACARE roadmap for 2050 identifies the need and sets objectives for significant reductions for a range of emissions. It is widely recognised that the opportunities to come close to or achieve these targets are limited.

To solve these issues a number of propulsion systems have been employed in different aircraft. Most systems use fossil fuel sources for economic reasons and also due to their very high energy density and specific energy. The prevalence of the gas turbine has also led to fossil fuels being a desirable propulsion mechanism for aircraft. This has led to developments for improving the performance of fossil fuel burning gas turbines, however these still produce water vapour. Engines which utilise other forms of energy carriers, such as hydrogen, have been shown to be lower in emission but can release larger volumes of water which may be released into the atmosphere.

Many modern systems focus on attempting to limit the impact of CO2 emissions from aircraft in order to reduce the negative impact of the use of the aircraft on the environment. It is known that such an approach may assist in limiting the negative side-effects of aircraft usage. However, some research speculates that the need to reduce CO2 may lead to an increase in contrails.

Alongside emissions of exhaust gases, emissions of contrails are known to be relatively damaging to the environment. Rapidly condensing water vapour from the aircraft may freeze to form cirrus-type clouds of around a mile in width can form complex merged cloud systems and can last for minutes or hours. The effects of these clouds including high level clouds are complex, but may be simplified as follows:
1) Clouds reflect and can absorb incoming radiation, e.g., visible and infra-red leading to potential local increase in temperature whilst providing shielding to features below the cloud from the otherwise higher heating effects.
2) Higher level clouds over a warmer surface can absorb and reflect radiation leading to an increase in temperature of features in the proximity of the cloud and features below it.

This is further accentuated by the following features:
A) Higher level clouds can result in greater reflection back to Earth than lower level clouds of similar size;
B) Higher level clouds of the same size as lower level clouds provide a smaller area to reflect radiation away from the Earth; and,
C) The amount of absorbed and reflected radiation is dependent on droplet/crystal geometry, temperature and prevalence.

Modern research indicates that by 2050 a threefold increase in the warming effect of contrails can be expected. This may be greater in effect than that of CO2.

Therefore, despite these advances, there remain a number of problems that have affected aircraft reduction in emissions. The inventors of an invention described herein have however created an alternative fluid release system which has a wide range of previously unavailable advantages which are described herein.

### SUMMARY OF THE INVENTION

The present disclosure is concerned with fluid release systems and specifically to aircraft fluid release systems which can be the cause of significant harm to the environment. Aspects of the disclosure are set out in the accompanying claims.

Viewed from a first aspect there is provided a fluid release system for a fuel cell, the system comprising: a conduit for communicating water from the fuel cell to one or more outlets; and, a water discharge arrangement arranged to selectively release water from the one or more outlets, wherein the water discharge arrangement is arranged to controllably open the one or more outlets to selectively release water from the one or more outlets.

Viewed from a second aspect there is provided a fluid release control system for controlling release of a fluid from an aircraft, the system comprising: a controller for detecting at least one of atmospheric conditions and geographic information; a transmitter for transmitting a signal based on the at least one detected atmospheric conditions and geographic information, the transmitter in use transmitting a signal to a receiver on an aircraft, wherein in response to receiving a signal based on the at least one detected atmospheric conditions and geographic information, water is released from the aircraft.

Viewed from a third aspect there is provided a method of releasing fluid for a hydrogen fuel cell, the method comprising: providing a conduit for communicating water from a fuel cell to an outlet; providing a water discharge arrangement arranged to selectively release water from the one or more outlets; and, controllably opening one or more outlets to selectively release water from the one or more outlets.

Viewed from a fourth aspect there is provided a fluid release system for a power generating element, the system comprising: a conduit for communicating water from the power generating element to one or more outlets; and, a water discharge arrangement arranged to selectively release water from the one or more outlets, wherein the water discharge arrangement is arranged to controllably open the one or more outlets to selectively release water from the one or more outlets.

### BRIEF DESCRIPTION OF THE DRAWINGS

One or more embodiments will now be described, by way of example only, and with reference to the following figures in which:

FIG. 1 shows a schematic of a fluid release system according to an example;

FIG. 2 shows a schematic of an aircraft;

FIG. 3 shows a schematic of an aircraft;

FIG. 4 shows a schematic of an aircraft according to an example;

FIG. 5 shows a schematic of an aircraft according to an example;

FIG. 6 shows a schematic of an aircraft according to an example;

FIG. 7 shows a schematic of an air flight path from below 2000 feet, through a contrail altitude boundary wherein controlled contrail formation may occur and then back to below 2000 feet; and,

FIG. 8 shows a block diagram of a fluid release system.

### DETAILED DESCRIPTION

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

The present disclosure is concerned with fluid release systems and specifically to aircraft fluid release systems which can be the cause of significant harmful gaseous emissions.

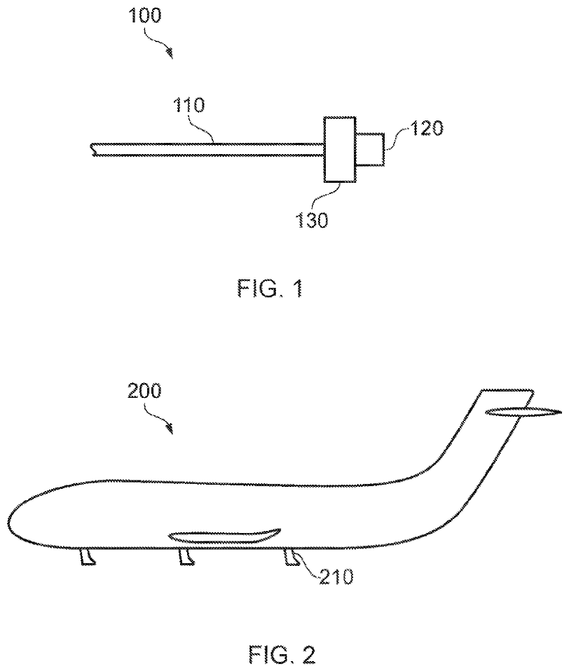

FIG. 1 shows a fluid release system for a fuel cell, the system having a conduit for communicating water from the fuel cell to one or more outlets. The system also has a water discharge arrangement arranged to selectively release water from the one or more outlets. The water discharge arrangement is arranged to controllably open the one or more outlets to selectively release water from the one or more outlets.

Present fuel emission systems on aircraft are focused on reducing the harmful emissions that are produced during the use of such aircraft. There are advantages to be gained from reducing these emissions in terms of environmental benefits. In relation to radiative forcing, contrails are particularly relevant and reduction of the production of these is of interest.

The arrangement shown in FIG. 1, may be used to reduce such harmful emissions. In FIG. 1 there is shown a water discharge arrangement which controllably releases water from the conduit to the outlet. The water then exits the arrangement. The water may be prevented from exiting the arrangement so as to reduce harmful emissions in the form of water vapour which can result in positive radiative forcing and therefore contribute to climate change.

The system shown allows for fluid to be released in a controlled manner. In an example, such as a fuel cell in an aircraft, the water produced from the fuel cell may be released from the aircraft system in a controlled manner. In an example, the water may move through a conduit which is arranged to communicate water from the fuel cell to an outlet of the aircraft. The outlet may be arranged on the outer shell or the like of the aircraft. A sensor is arranged to sense atmospheric conditions proximate to the outlet, such as the atmospheric conditions through which the aircraft is passing. A water discharge arrangement is arranged to release water from the outlet. In an example, the water discharge arrangement may be a switch or release valve or the like. The water discharge arrangement may be a closably openable nozzle to release water or the like. The system also has a water conditioner which is arranged to cause a modification to a characteristic of the water in the water conditioner, in response to determined atmospheric conditions from the sensor. The sensor may also or instead detect geographic information such as the local geographic location or geographic formations. Knowledge of the geographic location may assist in the calculation as to whether or not to release water, and if releasing water under what conditions. The sensor may also or instead detect, for example, ground temperatures (e.g., for the area below the aircraft), the time and date, and incident radiation at the geographic location. This incident radiation may be radiation from space (including incident solar radiation) which may be infra-red radiation.

Geographic formations, such as mountain ranges or large seas or the presence or absence of cities or the like which may alter the reaction of water when released from the system (whether by pressure or the like) or may alter the decision as to release water from the system (e.g. rainfall over an uninhabited area is less of a social concern than over a densely populated area) are also useful information in the decision as to whether to release water or not from the system.

In use, the system senses and determines the atmospheric conditions proximate to the outlet and then conditions the water in the water conditioner. This conditioning may take the form of affecting any of the following characteristics of the water in the water conditioner: pressure; temperature; density; viscosity; atomisation size; buoyancy; droplet/crystal geometry (i.e., the size and shape of the droplet or crystals); crystallisation propensity; and, vapour phase content. Other characteristics may include for example flow rate of the water prior to and during egress of the water from the system, dispersion angle, the prevalence of certain crystallisation sizes or shapes and homogeneity within those and the prevalence of water droplets. Each of these factors can be controlled so as to affect the range of desired wavelengths to be absorbed and scattered, alongside the scatter effects. The infra-red wavelength or wavelengths of choice can be selected so that clouds are formed which preferentially absorb and scatter wavelengths in that wavelength region. Controlling the parameters as listed above, enables control over the wavelengths of radiation that are preferentially absorbed and scattered. Therefore, enabling controlled radiation absorption via created cloud formations.

In this way, the water can be conditioned prior to releasing the water from the system. Moreover, the water can be conditioned in response to the atmospheric conditions. In this way, the conditioning applied to the water can be selected so as to control the effect of the water when released into those atmospheric conditions. The conditioning may allow control over whether released water forms clouds upon introduction to the atmosphere or drop out of the atmosphere as rainfall. Control of this is advantageous for a plurality of reasons, such as control over negative radiative forcing (for cloud formation) or lack of positive radiative forcing (for rainfall).

Standardly when water is released from aircraft systems into the atmosphere, the water forms contrails which cause a negative impact on the environment. With the invention as disclosed herein, if the atmospheric conditions are recognised as having characteristic that would lead to contrails being formed by the release of water from the aircraft, the system may opt against releasing the water from the aircraft. In this way, the water can be released in more favourable atmospheric conditions. The water may be maintained in a ballast tank or the like until more favourable atmospheric conditions are detected. The water may be maintained in the ballast tank during for example taxiing, or on approach or in conditions wherein release of water has negative impact. This may be as a result of radiative forcing, though may be for other reasons. A reason for not releasing water may be, for example, not releasing water while on or approaching a runway to prevent wetting the runway which could be a safety concern, or local area around the airport which could be a social concern (such as dropping large amounts of water on residential buildings). The ballast tank may also provide a reduction to the trim drag needed.

Furthermore, in other atmospheric conditions, conditioned water from the water conditioner may be released into the atmospheric conditions and create contrails which have a negative radiative forcing effect thereby providing a radiative cooling effect. The conditioning of the water may affect one or more characteristics of the water. This conditioning is performed as a result of the determination of the atmospheric conditions so as to allow the release of water which ultimately results in specific contrails which provide the radiative cooling effect. This provides a significant advantage over present systems, and in particular treats the water as a opportunity to provide radiative cooling rather than merely a substance with a negative trait which is to be minimised, as all modern systems attempt.

The present disclosure is a fundamental change in the direction of thinking regarding how to improve the environmental impact of emissions from propulsion systems. The system could well be applied to any system which is producing water vapour, not necessarily just water from a fuel cell. Indeed, this system could apply to any fluid which can be captured and have characteristics affected by conditioning from the conditioner, provided that fluid is one that can absorb and or scatter radiation (such as infra-red radiation) as a fluid.

The sensor for sensing atmospheric conditions proximate to the outlet may be arranged to sense any of pressure, temperature, wind speed, relative air velocity of the fluid release system and the atmosphere, humidity; vapour phase content of the atmospheric conditions proximate to the outlet; and local weather systems. Other factors that may be sensed include altitude and the time of day (so as to gain an indication as to whether it is night or day at that location). In an example wherein the system is used on an aircraft, these atmospheric conditions relate to the atmospheric conditions through which the aircraft is travelling. The sensor may be arranged on an outer surface of the aircraft or may be partially arranged on an outer surface of the aircraft. Suitable sensors may include passive and or active sensors such as optical, in visual and/or IR spectrum, LIDAR, RADAR e.g. x-band, and PIV (particle image velocimetry).

In an example, the sensor may be arranged not on the surface of the aircraft. In examples, the sensors may be wirelessly connected to the system so as to provide a determination of the atmospheric conditions proximate to the outlet. The sensors may be ground-based sensors which send communication to a receiver within the system. The sensors may alternatively or additionally be satellites or the like. The sensors may be based on other aircraft that are in the local area, which may be on a flight path ahead of the aircraft so as to provide information on the atmospheric conditions about to be encountered.

The system may have a controller for receiving information from the sensor. The controller may be arranged to receive wireless communication from the sensor. The controller may determine from the signals from the sensor the atmospheric conditions. The controller may then send signals to the water conditioner to control the conditioning applied to the water prior to release of the water.

A concern in noting whether to release water or not to release water depends on the net movement of thermal energy in the atmospheric conditions. In a specific embodiment, the broad direction of net movement of thermal energy is a relevant factor to consider. If thermal energy is broadly moving towards the Earth from space, water may be released and contrails may be formed to provide additional albedo against this thermal energy and therefore provide negative radiative forcing. If thermal energy is broadly moving from Earth to space, water may not be released so as to prevent contrails forming. Alternatively, water may be released, but controllably released so as to prevent formation of contrails by virtue of the characteristics of the water which have been modified prior to release.

The system disclosed herein may release water in a solid, or crystalline, or partially crystalline form. This may allow for cloud formation to occur, or for the water to drop out and not form a cloud should this be preferable at the time and location of water release.

The system disclosed may release water in a liquid or gaseous form. The conduit through which the water passes to the outlet may have one or more heaters arranged around it so as to provide heat to the conduit. In an example, the heater may be a heat exchanger or the like. This heat will help prevent the water from cooling as it passes from the water conditioner to the outlet. This may assist in avoiding water freezing in the conduit which can lead to significant damage to, or causing undesirable blocking in, the conduit. In a similar manner, the conduit may have a cooling element to prevent the water from warming as it passes from the water conditioner to the outlet. Alternatively or additionally, the water may be cooled by skin cooling as the bay is at from around −55° C. to around −60° C.) or via ambient air temperature.

The sensor and controller work to detect and forecast from either or both of the atmospheric conditions and the geographic information which direction thermal energy is travelling. If thermal energy is travelling towards the Earth from space, cloud formation may be beneficial to provide reflection of incident thermal energy. If thermal energy is travelling towards space from Earth, cloud formation may be detrimental as cloud cover may disrupt exit of thermal energy from the Earth. The system disclosed herein may also utilise performing calculations of whether or not to release water and how best to condition the water prior to release via machine learning models, neural networks, historical data (related to the area or atmospheric conditions for example) or a combination thereof.

The system disclosed herein may be a closed loop system. As the system is moving and/or as the system releases the water into the atmosphere, the atmospheric conditions will vary. As these conditions vary, the sensor senses the change in conditions. As such, the atmospheric conditions determined will be different which may lead to the water conditioner providing a different conditioning effect to the water. If a characteristic of the water is modified in a different way, the water may then continue to be released or the water may be not released. This outcome may change as a result of the change in atmospheric conditions.

In this way, the system disclosed herein is a reactive and sensitive system which can release water from the system when it is advantageous to do so and prevent release of water from the system when it is disadvantageous to do so. Similarly, the condition of the released water can be altered so as to release the water in an advantageous manner for the atmospheric conditions detected at that time. In this way, an adaptive system is provided which enables water to be released so as to achieve a beneficial effect over all present systems.

FIG. 2 shows a schematic of an aircraft with locations of water drains identified. The water drains may be for potable water and for waste or greywater. Typically, these are arranged towards the bottom of the aircraft. These drains can be used to release water from the aircraft.

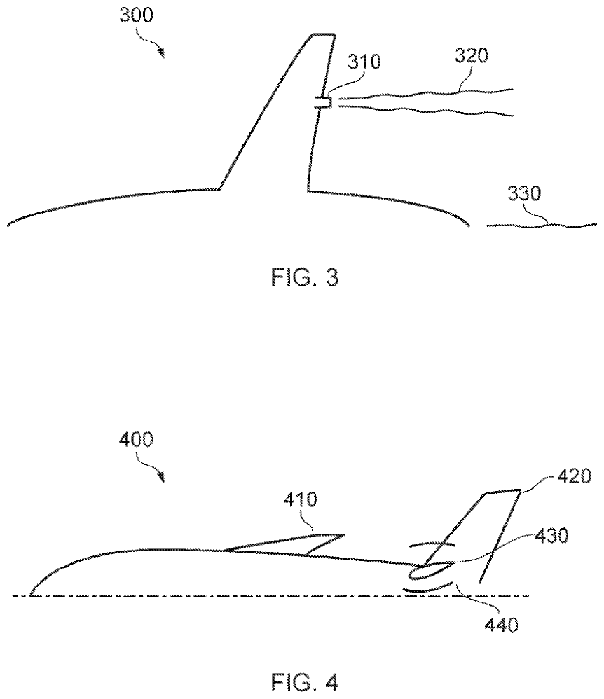

FIG. 3 shows a schematic of an aircraft with a location of a fuel jettison vent identified. The fuel jettison vent may be located so as to produce a jet exhaust which trails along and behind the aircraft, in the direction of travel. The auxiliary power unit exhaust is also shown as trailing behind the aircraft body.

FIG. 4 shows a side-on schematic of an aircraft with locations of possible outlets (vents) identified. The outlets (in the Figures noted as “vents”) may be located at the extremities of the aircraft. The released water may benefit from the particular aerodynamic effects experienced at these extremities. In particular, outlets may be located at wing tips, or on the empennage. Outlets may also be located on the circumferential extremity of the nacelles of on the centre sting of the nacelle.

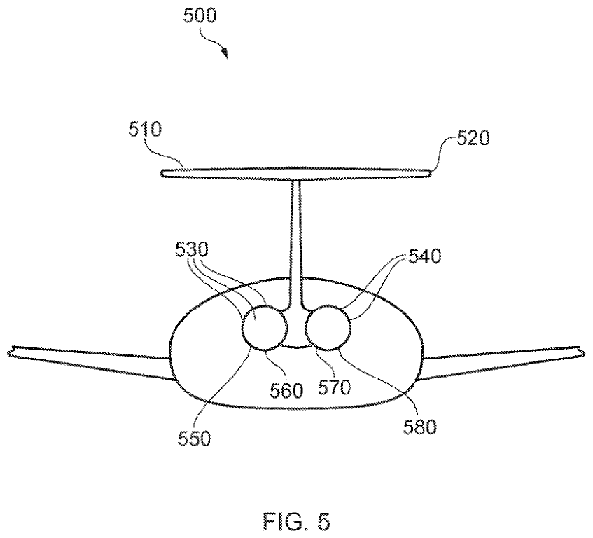

FIG. 5 shows a rear-view schematic view of an aircraft with locations of possible outlets (vents). The outlets may be located circumferentially around the nacelles or on the centre sting as shown. The outlets may be located on the extremes of the empennage. Location of the outlets on the nacelles means the conduit may benefit from passing nearby a high thermal energy location of the aircraft. In this way, the water in the conduit may be prevented from freezing. Though only one outlet location is shown as on the centre sting of one nacelle, outlets may be located on the centre stings of both nacelles if desired.

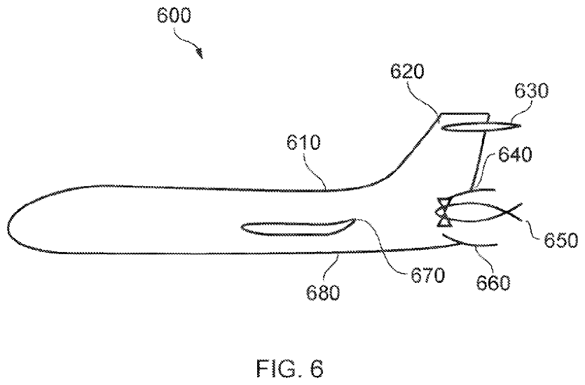

FIG. 6 shows a side-on schematic view of an aircraft with locations of possible outlet locations alongside possible sensor locations. The sensors are depicted in the Figures as “radiation sensors”. Radiation sensors may benefit from being located around the body of the aircraft so as to detect most accurately the overall atmospheric conditions and geographic information surrounding the aircraft. As such, sensors may be located on the topside and underside of the fuselage, as well as on the extremities of the empennage and wings. Sensors may also be located close to outlets so as to most accurately detect the conditions into which the released water will be sent. This will provide the most accurate response of the water once released into the atmosphere (as it has been well characterised) and therefore provide the most closely anticipated response of the water in the atmosphere.

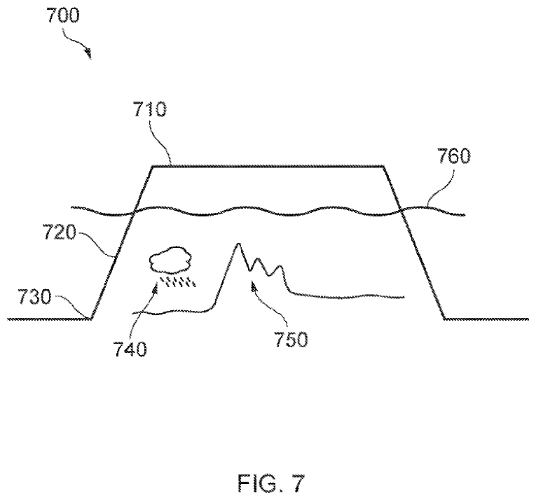

FIG. 7 shows a schematic of a flight profile of an aircraft with the system disclosed herein and possible release options. The system will detect precipitation and other weather conditions as well as geographic information such as the location of mountains and/or oceans. These are used in the calculation as to whether to release water or not, and in what form to release water. The flight profile below 2000 feet may result in no release of water. Above 5000 feet may be the controlled contrail formation zone, wherein, in suitable conditions, water is released so as to form cloud formation to provide beneficial negative radiative forcing.

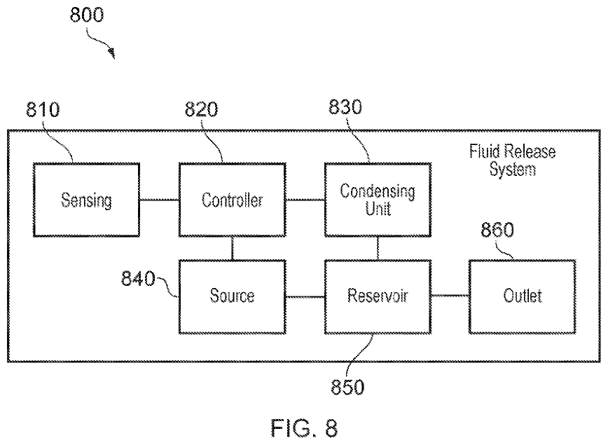

FIG. 8 shows a block diagram of a fluid release system. The fluid release system has a sensing element, a controller, a condensing unit alongside a source a reservoir and an outlet. The source may be the source of water, or fluid. The reservoir may be a tank for storing the water or fluid under undesirable release conditions. The condensing unit may condition the water or fluid into a desirable condition prior to release (or storing). The fluid or water may be released via the outlet once the sensing element (sensor) and the controller have detected that it may be beneficial to release the water or fluid either as rainfall or as cloud-forming.

As such, there is provided herein a fluid release system for a fuel cell, the system comprising: a conduit for communicating water from the fuel cell to one or more outlets; and, a water discharge arrangement arranged to selectively release water from the one or more outlets, wherein the water discharge arrangement is arranged to controllably open the one or more outlets to selectively release water from the one or more outlets.

The outlet of the system may be arranged on the outer surface of an aircraft. In an example, there may be more than one outlet arranged on the outer surface of an aircraft. There may be a plurality of outlets which are in fluid communication with the water conditioner. Each may have a separate conduit leading from the outlet to the water conditioner. Alternatively, some may share a portion of a conduit before, for example, the conduit branches off to supply water to the different locations in which the different outlets are arranged.

The outlets may be arranged, for example, across the fuselage of an aircraft. The outlets may be arranged across the wingspan of the aircraft. The outlets may be selectively operated to allow release of water through the outlets. In this way, only one outlet, or a subset of outlets, of a set of outlets may be activated if the release of water is desired over only a small area. This may be when no cloud or a small cloud is desirable in the conditions.

Alternatively, a full set of outlets may be operated to release water over a wide area. This may be advantageous when a wide cloud formation is desired to be produced to, highly effectively, reflect thermal energy moving towards Earth from space. In this way, the cloud can be effectively produced so as to generate high levels of radiative cooling. In an example, outlets arranged along the full wing span of the aircraft would provide a very wide cloud formation zone. Furthermore, the cloud formation from water released from outlets located along the wings is further encouraged as a result of the vortices which are generated near wingtips. As such, this is a particularly effective location from which to deliberately and controllably produce cloud formation from conditioned water.

Components of the system may be arranged in various locations in the aircraft. For example, it is advantageous to avoid freezing of the water in the conduit. As such, location of the conduits in say the guide vanes of the aircraft may utilise warmth from the exhaust gas to prevent freezing. Outlets may be arranged across a large or small span of the aircraft depending on the desired area over which water may be released. The sensors may be arranged over the surface of the aircraft so as to detect conditions around the aircraft. Sensors may also be ground based or non-ground based (satellites or on other aircraft in the local area). The sensors may be part of a fluid release control system which is separate to the fluid release system. The sensors may signal messages to the aircraft via radio signals or the like.

A fluid release system may have a transmitted for transmitting a signal based on detected atmospheric conditions and geographic information from the sensor to an aircraft. The signal may be received by a receiver on an aircraft. Once received, this signal may command the aircraft as to release or not release water from the aircraft. This signal may also command in which form water is to be released. Alternatively, the signal may merely send information relating to the atmospheric conditions and geographic information and the aircraft may possess a controller which decides whether or not take any action and what form that action is to take.

The fluid release control system may be ground station or a non-ground based station which can communicate efficiently across a plurality of aircrafts based on atmospheric conditions and geographic information at the locations of the respective aircrafts. Indeed, with one fluid release control system communicating with a plurality of aircraft, a highly efficient system may be produced wherein each aircraft does not need its own detecting equipment. The fluid release control system having the detecting equipment. The aircraft may then merely have a responsive openable outlet, and optionally the water conditioner, so as to respond to the commands from the fluid release control system as to whether or not to release water, and optionally in which form: that which causes cloud formation or that which causes rainfall.

The fluid release system may be arranged within an aircraft, such as arranged on or within the wing tips, the empennage extremities (e.g. the horizontal and vertical tail planes), the centrebodies and propulsors, and/or the nacelles. The arrangement may take advantage of any natural aerodynamic effects such as allowing for changing volumetric prevalence of the conditioned water being released. This changing volumetric prevalence may take into account how many of the water droplets are present within a set unit volume.

In an series of example, the following approaches may take place though these may vary based on the detected atmospheric conditions and geographic information: at low altitudes, around 2000 feet and below the water may held in a tank and not released; below 5000 feet the water may be held in a tank and not released when above built up areas, and released if over non-built up areas. During the night, high level clouds may be prevented from forming, but release of the water as rain or as low level clouds may occur. During the day, clouds may be formed if there are favourable conditions for reduced or negative forcing resulting from the clouds, for example if space incident infra-red radiation is higher than Earth emitted infra-red radiation. Clouds may also be formed if cirrus clouds are present and conditions are such that no further net effect regarding radiative forcing occurs from releasing water which goes on to produce clouds. Cloud formation may be avoided during the day if conditions are such that Earth emitted radiation is greater than space incident radiation, this might be the case over a hot desert or the like, or hot low level clouds which can release heat. In this case water may be released as rain or held in the tank.

As such, in a first set of atmospheric conditions and/or geographic information, water is released, and, in a second set of atmospheric conditions and/or geographic information, water is not released. Further, when water is released the water may be released so as to form rain, or water may be released so as to form clouds. Each of these decisions may be taken based on the calculation relating to radiative forcing which depends on the atmospheric conditions and/or geographic information.

In an example, the water may be released from the system to form clouds at a lower altitude than the altitude at which the water was released. Depending on atmospheric conditions and the geographic information, the cloud formation could occur at a lower or higher altitude which may be controlled by the conditioning of the water prior to release. In example, the water may be conditioned so as to fall come distance through the air as rainfall and subsequently form cloud formation at a desirable lower altitude.

Arrangement of the fluid release system within the aircraft may allow advantage to be taken of other effects, such as the hot thermal areas and the cold thermal areas of the aircraft. For example, the conduit may carry the water from the fuel cell through different sections of the aircraft. In an example, the conduit may run through the outlet guide vanes and use the thermal energy of the exhaust gas to remove heat from the exhaust and keep the water hot, this will prevent freezing and blocking of the conduit. It is advantageous to avoid impingement of water, supercooled water or ice onto the frame, and so this should be avoided in arrangements.

Furthermore, the use of a fuel cell to provide electrical power results in only the emission of H₂O, as opposed to harmful gaseous emissions produced by standard combustion engines. This H₂O may be captured and used within the aircraft as potable or non-potable H₂O.

The arrangement disclosed herein may be used with any power generating element which provides a fluid which can be conditioned and released to form clouds. This includes gas turbines, combustion engines, and fuel cells; the internal combustion engine, a wankel engine, or an engine utilising the wankel, otto cycle or similar, a mixed cycle engine or a solid oxide fuel cell type may also be used with the disclosed arrangement.

1.-21. (canceled)

22. A fluid release system for a fuel cell, the system comprising:
a conduit for communicating water from the fuel cell to one or more outlets; and,
a water discharge arrangement arranged to selectively release water from the one or more outlets,
wherein the water discharge arrangement is arranged to controllably open the one or more outlets to selectively release water from the one or more outlets.

23. The fluid release system of claim 22, further comprising:
a controller for detecting at least one of atmospheric conditions and geographic information,
wherein the controller is arranged to provide a signal based on the atmospheric conditions or the geographic information to the water discharge arrangement,
wherein the atmospheric conditions are atmospheric conditions proximate to the one or more outlets, and
wherein the geographic information is the local geographic information of the system.

24. The fluid release system of claim 23, further comprising:
a sensor for sensing at least one of atmospheric conditions proximate to the one or more outlets and local geographic information,
the sensor arranged to send signals based on at least one of atmospheric conditions and geographic information to the controller.

25. The fluid release system of claim 23, wherein the controller is arranged to receive signals based on at least one of atmospheric conditions and geographic information from detection systems external to the fluid release system.

26. The fluid release system of claim 23, wherein the signal based on the atmospheric conditions is related to at least one of:
pressure;
temperature;
wind speed;
relative air velocity of the fluid release system and the atmosphere;
humidity;
vapor phase content; or,
local weather systems.

27. The fluid release system of claim 23, wherein the signal based on the geographic information is related to at least one of:
local geographic location;
local geographic formations;
ground temperature;
time and date; or,
incident radiation.

28. The fluid release system of claim 23, wherein the system is arranged to selectively release water from the outlet according to the at least one of the detected atmospheric conditions and geographic information;
wherein, in a first set of atmospheric conditions or geographic information, water is released,
and wherein, in a second set of atmospheric conditions or geographic information, water is not released.

29. The fluid release system of claim 22, further comprising:
a water conditioner arranged to cause a modification to a characteristic of the water, in response to at least one of the detected atmospheric conditions and geographic information.

30. The fluid release system of claim 29, wherein the characteristic of the water is selected from one of:
pressure;
temperature;
density;
viscosity;
atomization size;
buoyancy;
droplet/crystal geometry;
crystallization propensity; or,
vapor phase content.

31. The fluid release system of claim 22, wherein the water discharge arrangement is arranged to control a dispersion angle of the one or more outlets.

32. The fluid release system of claim 22, wherein the fluid release system is arranged within an aircraft.

33. The fluid release system of claim 22, further comprising at least one heater arranged in use to provide thermal energy to at least a part of the conduit.

34. A fluid release control system for controlling release of a fluid from an aircraft, the system comprising:
a controller for detecting at least one of atmospheric conditions and geographic information; and
a transmitter for transmitting a signal based on the at least one detected atmospheric conditions and geographic information, the transmitter in use transmitting a signal to a receiver on an aircraft,
wherein in response to receiving a signal based on the at least one detected atmospheric conditions and geographic information, water is released from the aircraft.

35. The fluid release control system of claim 34, wherein the fluid release control system is arranged within a ground control device.

36. The fluid release control system of claim 34, wherein the fluid release control system is arranged within a non-ground based device.

37. The fluid release control system of claim 34, wherein the transmitter is arranged to transmit a signal to a water conditioner of the aircraft to cause a modification to a characteristic of the water.

38. The fluid release control system of claim 34, wherein the transmitter is arranged to transmit a signal to a water discharge arrangement to control a dispersion angle of one or more outlets through which water is released from the aircraft.

39. A fluid release system for a power generating element, the system comprising:
a conduit for communicating fluid from the power generating element to one or more outlets; and,
a fluid discharge arrangement arranged to selectively release fluid from the one or more outlets,
wherein the fluid discharge arrangement is arranged to controllably open the one or more outlets to selectively release fluid from the one or more outlets.

40. The fluid release system of claim 39, wherein the power generating element is any of:
a gas turbine;
a combustion engine; or
a fuel cell.
